(19) United States
(12) Patent Application Publication
(10) Pub. No.: US 2006/0224760 A1
(43) Pub. Date: Oct. 5, 2006

(54) Method and system for providing streaming content in a peer-to-peer network with network coding

(75) Inventors: Mingjian Yu, Beijing (CN); Xiangyang Chen, Beijing (CN)

Correspondence Address: HAYNES AND BOONE, LLP, 901 MAIN STREET, SUITE 3100, DALLAS, TX, 75202, US

(73) Assignee: 1000 Oaks Hu Lian Technology Development (Beijing) Co., Ltd., Beijing (CN)

(21) Appl. No.: 11/289,969

(22) Filed: Nov. 30, 2005

Related U.S. Application Data
(60) Provisional application No. 60/662,131, filed on Mar. 15, 2005.

(51) Int. Cl. G06F 15/16

(52) U.S. Cl. 709/231

(57) ABSTRACT

A system, method, and computer-readable medium distributing streaming media content to clients in a peer-to-peer network. A streaming source divides the streaming media content into a plurality of data segments of equal length. A request from a peer client is received for at least a portion of the streaming media content. A subset of the plurality of data segments by a linear network coding routine is encoded into an encoded data block. The encoded data block is sent to the peer client.

### RELATED APPLICATION DATA

This patent application claims the benefit of provisional U.S. Patent Application Ser. No. 60/662,131, filed Mar. 15, 2005.

### BACKGROUND

Delivery of streaming multimedia content typically requires the streaming content to be split into data blocks or segments. Each data segment may contain a group of video frames. Video data segments each containing one or more video frames are transmitted from a streaming source server to clients.

In a peer-to-peer network, data blocks may be transmitted from peer clients to other peer clients. By providing streaming content in a peer-to-peer network, a peer client may connect to several other peer clients and request video data segments. The requested video data segments are sometimes available only at a few nodes within the peer-to-peer network. Thus, the availability of streaming content within a peer-to-peer network is not satisfactorily reliable.

### BRIEF DESCRIPTION OF THE DRAWINGS

Aspects of the present disclosure are best understood from the following detailed description when read with the accompanying figures, in which:

FIG. 1 is a diagrammatic representation of an embodiment of a client-server network that may provide streaming services to various clients;

FIG. 2 is a diagrammatic representation of an embodiment of a peer-to-peer network that facilitates streaming content operation;

FIG. 3 is a diagrammatic representation of an embodiment of a linear network coding method for encoding streaming data segments;

FIG. 4 is a diagrammatic representation of an embodiment of encoded data block that comprises streaming segments encoded by a linear network coding routine;

FIG. 5 is a diagrammatic representation of an embodiment of a network for transmission of encoded data blocks to a peer client;

FIG. 6 is a diagrammatic representation of an embodiment of a software configuration that facilitates distribution of streaming content in a peer-to-peer network;

FIG. 7 is a diagrammatic representation of an embodiment of a linear network coding method implemented by encoding data block subsets separately at the source side;

FIG. 8 is a flowchart of an embodiment of a peer client processing routine for requesting and receiving linearly encoded data blocks by encoded segment subsets;

FIG. 9 is a flowchart of an embodiment of a source providing linearly encoded data blocks by subset to a requesting peer client;

FIG. 10 is a diagrammatic representation of an embodiment of a linear network coding routine implemented by repetitive encoding of data segments;

FIG. 11 is a flowchart of an embodiment of a peer client requesting linearly encoded data segments by sequence numbers of the requested segments; and

FIG. 12 is a flowchart of an embodiment of a source providing linearly encoded data blocks according to a requested data segment sequence number and a requested number of data segments.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Embodiments disclosed herein provide mechanisms for delivering encoded multimedia content in a peer-to-peer network from a source server to peer clients and from peer client to other peer clients. The source server divides streaming data into data blocks, or segments, of equal length, dynamically encodes some selected data blocks by a linear network coding method, and sends encoded data blocks to peer clients. A peer client, upon receipt of one or more of the encoded data blocks, may decode the received data blocks from representation vectors for the encoded data blocks and reconstruct the decoded data blocks into a native video format. The network coding method allows for several video data segments to be encoded into one or more encoded data blocks. The encoded data blocks may be delivered to different peer nodes. Thus, a peer client has a greater chance to obtain the encoded data blocks. In addition to increasing the likelihood of obtaining the desired streaming content, the downloading speed may be increased as well.

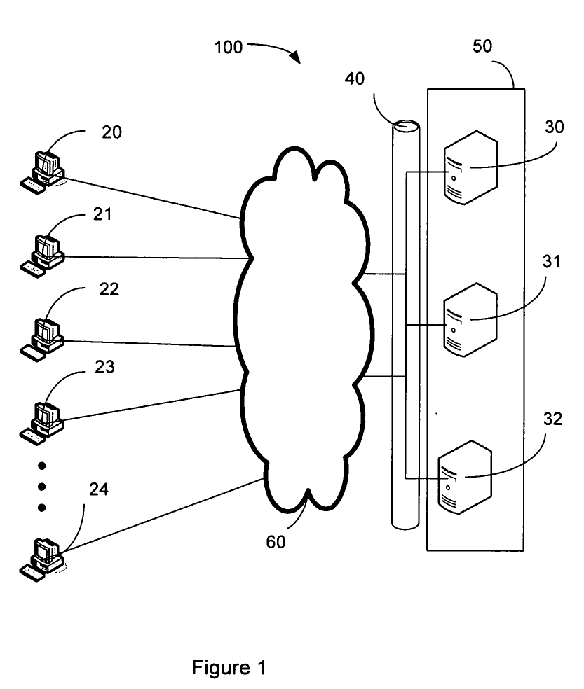

FIG. 1 is a diagrammatic representation of an embodiment of a client-server network 100 that may provide streaming services to various clients 20-24. Client-server network 100 comprises multiple content servers 30-32 configured in a cluster 50. Content servers 30-32 may store or otherwise access duplicate streaming content. For example, content servers 30-32 may access and stream content in a RealAudio, RealVideo, advanced streaming format (ASF), or another streaming media format. Content servers 30-32 may be interconnected by a network link 40, such as an Ethernet. Streaming services provided by cluster 50 may be load-balanced among content servers 30-32. Clients 20-24 are provided streaming services by connecting with cluster 50, for example by way of a public network 60, such as the Internet.

Each of content servers 30-32 may provide streaming service processing for a finite number of clients, and thus the client service capacity of cluster 50 is limited to the aggregate service capacity of content servers 30-32. If the demand placed on cluster 50 becomes too large, the streaming service quality provided to clients 20-24 may be degraded or one or more of clients 20-24 may be disconnected from cluster 50. Conventional solutions for addressing excessive loads placed on cluster 50 generally include expanding the processing capacity of cluster 50, for example by adding additional content servers to cluster 50, upgrading the capacity of existing content servers, or by other mechanisms. Such system reconfigurations are costly due to both hardware and labor expenses.

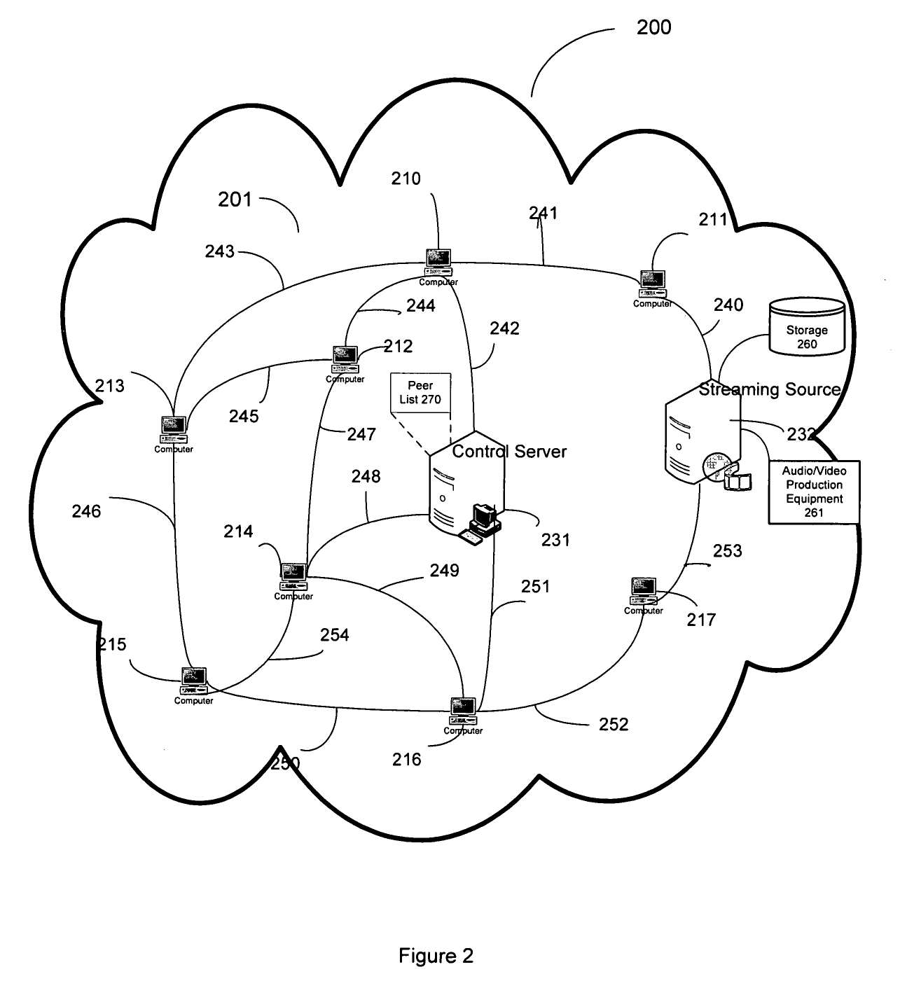

FIG. 2 is a diagrammatic representation of an embodiment of a peer-to-peer network 200 that facilitates streaming content operation. Network 200 includes various peer clients 210-217 that may be interconnected with other clients in network 200. Additionally, network 200 may include a control server 231 and a streaming source 232. One or more clients may connect with control server 231 and streaming source 232 in addition to other network clients. Clients 210-217 may connect with other network clients, control server 231 and streaming source 232 by network connections 240-254, such as wire, wireless communication links, fiber optic cables, or other suitable network media.

Control server 231 may facilitate connection of new clients within network 200 and organize clients 210-217 that have joined network 200. Clients 210-217 may be implemented as data processing systems, such as personal computers, wired or wireless laptop computers, personal digital assistants, or other computational devices capable of network communications.

Streaming source 232 may be implemented as a server that stores or accesses streaming content, such as video, audio, or the like, and streams the data to one or more clients in network 200. For example, the streaming content may be retrieved from a file that is accessed by streaming source 232 from a storage device 260. Alternatively, the streaming content may be produced from, for example, audio/video production equipment 261 that is interfaced with streaming source 232. The streaming content may comprise data encoded in a native streaming format, such as RealAudio formatted files, RealVideo formatted files, ASF, or another streaming format that may be processed by a streaming media application, such as RealPlayer, Windows Media Player, or another streaming media application. The native formatted streaming content may be encapsulated in a network transport format that facilitates transmission of data among peer clients of network 200. Streaming source 232 may divide streaming content into data segments that are distributed within network 200 as described more fully below. Various clients 210-217 may receive and store different data blocks of the streaming content.

Control server 231 maintains a peer list 270 that includes connectivity information, such as a network address and port number, of respective peer clients that are connected within peer-to-peer network 200. When control server 231 generates peer list 270, connectivity information of streaming source 232 may be the only connectivity information included in peer list 270. A client joins peer-to-peer network 200 by first connecting with control server 231 and submitting a request for peer list 270. The control server returns peer list 270 to the requesting client, and the client joins network 200 by selecting one or more nodes having connectivity information included in peer list 270 and connecting with the selected nodes.

When a new client joins peer-to-peer network 200, control server 232 may add connectivity information of the newly joining client to peer list 270. In this manner, as additional clients join peer-to-peer network 200, the availability of peer clients with which subsequently joining clients may connect is increased. Connectivity information of streaming source 232 may be removed from peer list 270, for example when the number of clients connected within peer-to-peer network 200 reaches a pre-defined threshold. In this manner, the streaming session load placed on streaming source 232 may be reduced. A client connected within peer-to-peer network 200 that desires streaming content originally provided by streaming source 232 may submit a query for the streaming content to peer clients with which the requesting client is connected. If no peer clients within network 200 have the requested streaming content (or no peer clients within network 200 are available for delivery of the streaming content to the requesting client), the requesting client may obtain the streaming content from streaming source 232.

A peer client that receives streaming content from streaming source 232 may be configured to cache or temporarily store the streaming content (or a portion thereof) for playback. Additionally, a client may distribute cached streaming content to other peer clients. Streaming content may be segmented by streaming source 232 into data blocks or segments that each have an associated sequence number. Playback of streaming content is performed by arranging data blocks into a proper sequence based on the data blocks' sequence numbers.

Network 200 may comprise a transient Internet network, and thus clients 210-217, control server 231, and streaming source 232 may use the Transmission Control Protocol/Internet Protocol (TCP/IP) suite of protocols to communicate with one another. Alternatively, network 200 may be implemented in any number of different types of networks, such as for example, an intranet, a local area network (LAN), or a wide area network (WAN). Additionally, control server 231 and streaming source 232 are shown as distinct entities within network 200. However, control server 231 and streaming source 232 may be collectively implemented in one or more common network nodes. FIG. 2 is intended as an example, and not as an architectural limitation, of embodiments described herein.

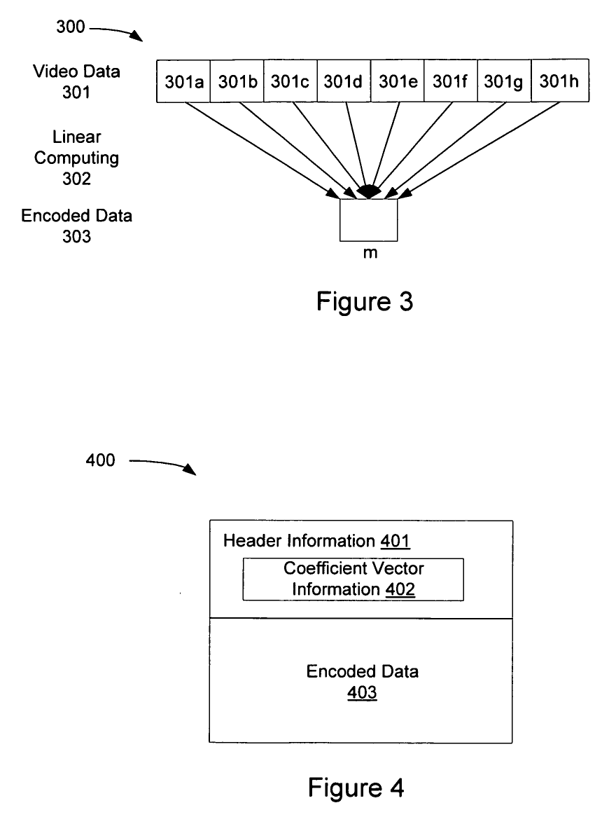

FIG. 3 is a diagrammatic representation of an embodiment of a linear network coding method for encoding streaming data segments. Streaming source server 232 (FIG. 2) preferably divides streaming content into streaming data segments of equal length. In the illustrative example, streaming content 301 comprises video data and is segmented by source server 232 into data blocks 301a-301h of equal length. Each of streaming content segments 301a-301h is preferably associated with a respective sequence number (N=1 through N=8). Sequence numbers associated with a streaming content segment are universally associated therewith for playback and transmission in a distribution network, such as peer-to-peer network 200, and are used to recognize data segments throughout the network system. Various methods may be implemented for segmenting streaming content 301 into streaming content segments.

One method for segmenting streaming content into streaming content segments for distribution in a peer-to-peer network comprises segmenting the streaming content into segments comprising segments of equal length. In this implementation, streaming content in a data segment may not start at the beginning of a video frame. To facilitate playback of streaming content segmented in this manner, a first playable video frame may be skipped to accommodate a frame that is not aligned with the streaming content segment. For example, an offset of the first video frame with an encoded data block may be specified.

Another method for segmenting streaming content into streaming content segments for distribution in a peer-to-peer network comprising dividing the streaming content into segments of approximate equal lengths and supplying padding zeros to extend the data segment to a maximum length. In this manner, the padding zeros facilitate encoding of the streaming content into segments of the maximum and equal length.

In accordance with a preferred embodiment, a computing method for encoding streaming content comprises a linear network coding routine 302 for producing encoded data 303 to a finite field. As referred to herein, a field is an algebraic object with two operations: addition and multiplication (represented by + and *). The addition and multiplication may or may not be ordinary, or conventional, addition and multiplication operations. Using addition (+), all elements of the field form a commutative group, with identity denoted by 0 and the inverse of an element a denoted by −a. Using multiplication (*), all elements of the field except 0 form another commutative group with identity denoted 1 and inverse of an element a denoted by a^{-a}. The element 0 has no inverse under multiplication. Moreover, the distributive identity must hold: a*(b+c)=(a*b)+(a*c), for all field elements a, b, and c.

There are a number of different infinite fields, including the rational numbers (fractions), the real numbers (all decimal expansions), and the complex numbers. Cryptography focuses on finite fields. For any prime integer p and any integer n greater than or equal to 1, there is a unique field with pⁿ elements in it, denoted GF(pⁿ) (“GF” standing for “Galois Field” named after the French mathematician who discovered them). Here “unique” means that any two fields with the same number of elements must be essentially the same, except perhaps for giving the elements of the field different names.

The case of p=2 and n=8, or p=2 and n=16, respectively denoted as GF(2⁸) or GF(2¹⁶) is sometimes used in processing encoding/decoding of data blocks.

Consider processing of symbols in a data block in the same position from the initial cycle of the processing method.
Let X=(x₁, x₂, x_{N});
where x₁ to xₙ are the symbols to be processed.

A set of coefficients for the linear computing method are selected. For example, let the following set represent the coefficients:
(a₁₁, a₁₂, . . . a_{1N});

By linear computation, the final symbol is obtained according to the following:

$${y}_{1} = {\sum }_{i = 1}^{N} {a}_{1 i} {x}_{i} ; ,$$

By selecting different coefficients N times, N symbols (y₁ through y_{N}) may be obtained:

$$Y = ( {y}_{1} , {y}_{2} , ⋯ {y}_{N} ) ; with$$

$${y}_{k} = {G}_{k} {X}^{T} = {\sum }_{i = 1}^{N} {a}_{ki} {x}_{i} ;$$

That is,

$$Y = {GX}^{T} = [ \begin{matrix}{a}_{11} & {a}_{12} & ⋯ & {a}_{1 N} \\ {a}_{21} & {a}_{22} & ⋯ & {a}_{2 N} \\ & & ⋯ & \\ {a}_{N 1} & {a}_{N 2} & ⋯ & {a}_{NN}\end{matrix} ] \cdot [ \begin{matrix}{x}_{1} \\ {x}_{2} \\ \\ {x}_{N}\end{matrix} ] ;$$

The receiver may then decode Y by inverting matrix G according to the following:
X=G⁻¹Y;

Note that in order to decode symbols X (x₁ through x_{N}), the matrix should be full rank. A pre-defined set of coefficients may be implemented to ensure that the matrix is full rank. In other implementations, a randomly generated set of coefficients may be implemented to provide the matrix at full rank with large probability although not guaranteed in each instance.

FIG. 4 is a diagrammatic representation of an embodiment of encoded data block 400 that comprises streaming segments encoded by routine 302. Encoded data block 400 may include overhead information, such as header information 401 and coefficient information 402. Other information, such as digest information for providing error correction of the transmitted data block, may also be included in the header. In general, the overhead information occupies only a small percentage of data block 400.

FIG. 5 is a diagrammatic representation of an embodiment of a network 500 for transmission of encoded data blocks to a peer client. A peer client 520 requests encoded data blocks from different sources. Peer client 520 may request encoded data blocks from one or more peer clients 501-503 and/or a streaming source server 532 from which the encoded data blocks were originated and distributed within network 500. Peer client 520 may request common or different data blocks from various sources available in network 500. In the illustrative example, peer client 520 requests two data blocks (M1 and M2) from peer client 501, one respective data block from peer clients 502 and 503 (M3 and M4, respectively), and one data block (M5) from streaming source server 532. Network 500 may be implemented as a peer-to-peer network, such as peer-to-peer network 200 shown in FIG. 2.

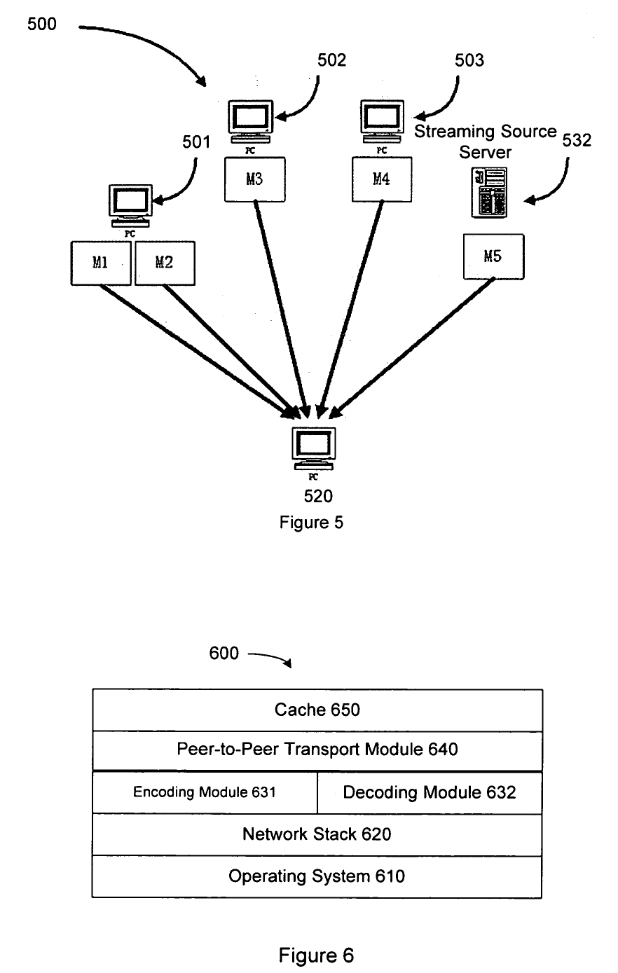

FIG. 6 is a diagrammatic representation of an embodiment of a software configuration 600 that facilitates distribution of streaming content in a peer-to-peer network. Software configuration 600 comprises sets of computer-executable instructions or code that may be fetched from a memory and executed by a processing unit of a data processing system. Software configuration 600 is preferably run by a streaming source, such as streaming source server 232, from which streaming content is originated in peer-to-peer network 200.

Software configuration 600 may include an operating system 610, such as a Windows operating system manufactured by Microsoft Corporation of Redmond, Wash., an OS/2 operating system manufactured by International Business Machines Corporation of Armonk, N.Y., or the like. Operating system 610 may include a network stack 620 for providing network communications. For example, network stack 620 may be implemented as a transmission control protocol/Internet protocol (TCP/IP) stack. Additionally, software configuration 600 may include a streaming data encoding module 631 and decoding module 632 that is adapted to format streaming content in a peer-to-peer transmission format for transmission across a peer-to-peer network by way of peer clients operating in conformity with the peer-to-peer transmission format.

Software configuration 600 may include a peer-to-peer transport module 640 that comprises logic for self-administration of the peer-to-peer network structure. For example, peer-to-peer transport module 640 may provide self-adjusting functions of the peer client location in the peer-to-peer network topology. Additionally, transport module 640 may provide network transmission functions for peer-to-peer transport of encoded data streams. For example, transport module 640 may supply peer-to-peer transport encoded packets to network stack 620 for transmission in the peer-to-peer network.

Software configuration 600 may include a cache 650 that may be used to facilitate the fluency or contiguity of stream playing. Cache 650 may included decoded data blocks or encoded data blocks.

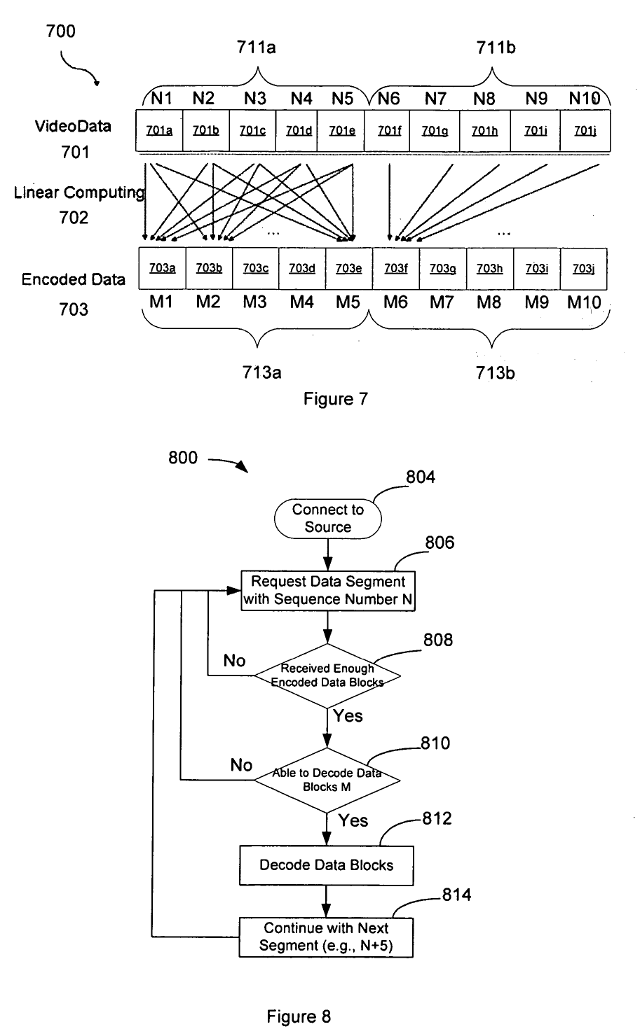

FIG. 7 is a diagrammatic representation of an embodiment of a linear network coding method implemented by encoding data block subsets separately at the source side. Source server 232 or a peer client may dynamically encode the streaming content. In this implementation, subsets of video data segments are encoded by a linear network coding routine 702 into encoded data blocks. In the illustrative example, streaming content 701 is segmented into video data segments 701a-701j, and subsets 711a-711b of video data segments 701a-701j are encoded to subsets 713a-713b of encoded data blocks 703a-703j. For example, each of video data segments 701a-701e of video data segment subset 711a are each encoded to encoded data blocks 703a-703e of encoded data block subset 713a. In a similar manner, each of video data segments 701f-701j of video data segment subset 711b are each encoded to encoded data blocks 703f-703j of encoded data block subset 713b. Only data segments of a common subset may be mixed or commonly encoded in encoded data blocks of a common encoded data block subset.

FIG. 8 is a flowchart 800 of an embodiment of a peer client processing routine for requesting and receiving linearly encoded data blocks by encoded segment subsets. A peer client connects to the source server 232 or to another peer client directed by control server 231 (step 804), and requests an encoded data block by specifying a sequence number N of the segment, e.g., by requesting a data segment with a sequence number N=5 (step 806). The peer client might concurrently connect to different sources and request the encoded data block in the same subset.

The peer client then receives an encoded data block through peer network 200. The encoded data block includes the segment having an associated sequence number N and other segments included in the segment subset that was encoded into the data block. An evaluation may be made at the peer client to determine whether additional encoded data blocks remain that include the requested segment (step 808). If additional encoded data blocks remain that include the requested segment, the peer client processing routine may return to step 806 to request an additional encoded data block including the requested segment. When enough encoded data blocks have been received, the peer client attempts to decode the encoded data blocks (step 810). If the peer client is unable to decode the encoded data blocks, the peer client processing may return to request an additional encoded data block including the requested segment according to step 806. If the encoded data blocks are able to successfully be decoded (step 812), the vectors for the same subset of data blocks are full rank. The peer client may then continue by requesting a next segment (step 814). The next requested segment has an associated sequence number that is incremented as a factor of the number of segments included in an encoded data block. In the examples provided herein, five segments are encoded in an encoded data block, and thus the client will next request an encoded data block that includes a segment having a sequence number N+5 from the source.

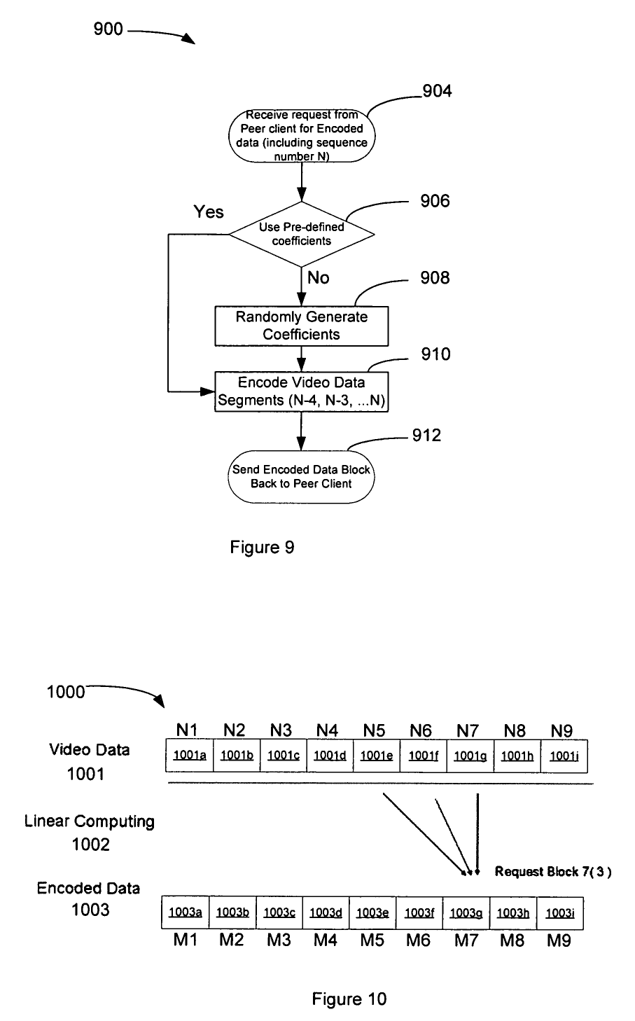

FIG. 9 is a flowchart 900 of an embodiment of a source providing linearly encoded data blocks by subset to a requesting peer client. Source server 232, or a peer client, receives a request for an encoded data block with a streaming data segment specified by sequence number N (step 904). The source may then evaluate whether to use pre-defined set of coefficients to encode data segments (step 906). If the source uses pre-defined coefficients to encode data segments, the source processing routine may proceed to encode data segments including the requested data segment having the associated sequence number N specified in the request and other data segments included in the data segment subset to which the requested data segment belongs (step 910). If it is determined at step 906 that the source does not use predefined coefficients for encoding data blocks, the source processing routine may proceed to randomly generate a set of coefficients (step 908), and then encode the video data segments with the randomly generated set of coefficients according to step 910. Once the data segments are encoded by the pre-defined or randomly generated coefficients, the source may send the encoded data block to the requester (step 912).

The source server or peer client may also send the statically encoded data block to the requester. To ensure successful decoding of encoded data blocks, a peer client requesting content from a source may provide part of its vectors of coefficients to the source server or the source peer. The source server or the source peer may then select coefficients for encoding based on the requesting client's vectors of coefficients to make sure the rank of the vectors is increased.

FIG. 10 is a diagrammatic representation of an embodiment of a linear network coding routine 1002 implemented by repetitive encoding of data segments. The encoding method depicted in FIG. 10 provides an alternative method for requesting encoded data blocks from source server or source peers. In this implementation, a peer client may repetitively request encoded data blocks by specifying a data block or segment 1001a-1001i sequence number and a number that specifies how many data segments preceding the requested segment should be encoded with the requested data segment. In the illustrative example, a peer client requests a data segment 1001g with sequence number N=7 and further specifies that three data segments (i.e., the data segment with sequence number N=7 and two data segments 1001e and 1001f preceding data segment 1001g with sequence number N=7) should be encoded. In the illustrative example, the request includes a designation formatted Y(X), where Y specifies the sequence number of the requested data segment and X specifies the total number of requested data segments. Thus, the illustrated request 7(3) comprises a request for data segment 1001g having a sequence number N=7 and the two preceding data segments 1001e and 1001f (having respective sequence numbers of N=5 and N=6).

The encoding method depicted in FIG. 10 may be implemented in an infinite field of sequence numbers. On an initial encoding cycle, a peer client may request an encoded block including a segment with a sequence number of, for example, N=5 and a single data segment. For example, the peer client may submit a request of 5(1) thereby indicating a segment with a sequence number of 5 and one segment to be encoded, i.e. the segment with sequence number N=5 itself.

Subsequently, the peer client may submit a request 8(2), indicating a request for a data segment 1001h having sequence number N=8 and a total of two data segments to be encoded. Because the first data segment is available (i.e., has previously been received by the peer client), the segment with sequence number N=6 should also be resolvable according to the following:

$$[ \begin{matrix}{y}_{5} \\ {y}_{6}\end{matrix} ] = [ \begin{matrix}{a}_{51} & 0 \\ {a}_{61} & {a}_{62}\end{matrix} ] \cdot [ \begin{matrix}{x}_{5} \\ {x}_{6}\end{matrix} ] ;$$

The peer client may submit subsequent requests of 9(3), 10(4), 11(5). In each of these instance, the data segments having respective sequence numbers of N=9, N=10, and N=11 should also be resolvable.

The peer client may then request a fixed number of segments to be encoded, e.g., by submitting requests of 12(5), 13(5), 14(5), etc. In each case, the requested data segments are able to be resolved for decoding based on the previously requested and available data segments.

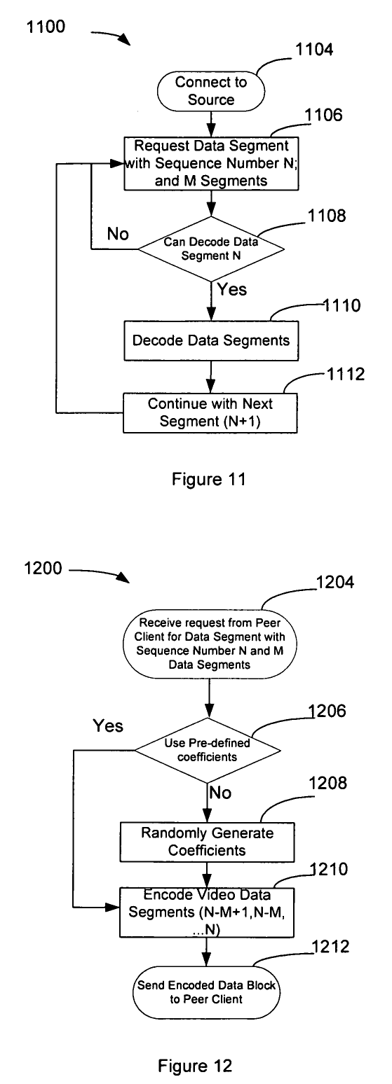

FIG. 11 is a flowchart 1100 of an embodiment of a peer client requesting linearly encoded data segments by sequence numbers of the requested segments. The peer client connects to source server 232 or a peer client(s) (step 1104), and submits a request thereto that specifies a data segment sequence number and a number (M) of how many data segments to be encoded (step 1106).

The peer client then receives the encoded data block, and evaluates whether the data segment with sequence number N is able to be decoded from the received encoded data block (step 1108). If the peer client is unable to decode the data segment, another request for the data segment may be submitted to the source according to step 1106. If it is determined that the data segment may be decoded from the encoded data segments at step 1108, the encoded data block is then decoded (step 1110). The peer client may then proceed to submit a request for a next data segment (step 1112).

FIG. 12 is a flowchart 1200 of an embodiment of a source providing linearly encoded data blocks according to a requested data segment sequence number and a requested number of data segments. The source server or the source peer receives a request for an encoded data block with a data segment having a sequence number N and a number M of segments to be encoded (step 1204). The source server or source peer then evaluates whether to use a pre-defined set of coefficients (1206). If the source is to use a pre-defined set of coefficients, the source processing routine may proceed to encode M data segments including the requested data segment having a sequence number N. Particularly, the source encodes a subset of M segments having sequence numbers (N−M+1, N−M, . . . N). If it is determined at step 1206 that the source is not to use pre-defined coefficients, the source processing routine may proceed to randomly generates coefficients (step 1208), and then encode M data segments including the requested data segment having sequence number N. The source server or source peer then may send the encoded data block including the M encoded data segments to the requester. In this implementation, the source server or the source peer may return an error when it does not have the video data segment with sequence number N to ensure the requester can decode the data segment with sequence number N.

The various functions, processes, methods, and operations performed or executed by the system can be implemented as programs that are executable on various types of processors, controllers, central processing units, microprocessors, digital signal processors, state machines, programmable logic arrays, and the like. The programs may be stored on a computer-readable medium for use by or in connection with a computer system or method. A computer-readable medium may be implemented as, for example, an electronic, magnetic, optical, or other physical device or means that can store a computer program for use by or in connection with a computer system, method, process, or procedure. Programs may be embodied in a computer-readable medium for use by or in connection with an instruction execution system, device, component, element, or apparatus, such as a system based on a computer or processor, or other system that can fetch instructions from an instruction memory or storage of any one or more suitable types. A computer-readable medium may be implemented as any structure, device, component, product, or other means that can store, communicate, propagate, or transport the program for use by or in connection with the instruction execution system, apparatus, or device.

The flowcharts provided herein depict process serialization to facilitate an understanding of the invention and are not necessarily indicative of the serialization of the operations being performed. The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, and the like.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of distributing streaming media content to clients in a network, comprising:
dividing, by a streaming source, the streaming media content into a plurality of data segments of equal length;
receiving a request from a peer client for at least a portion of the streaming media content;
encoding a subset of the plurality of data segments by a linear network coding routine into an encoded data block; and
sending the encoded data block to the peer client.

2. The method of claim 1, further comprising:
receiving the encoded data block from the streaming source; and
decoding, by the peer client, the received encoded data block when sufficient encoded data blocks are available to the peer client by using a linear network coding method.

3. The method of claim 1, further comprising:
receiving, by the peer client, a request from a second peer client for content of the streaming media content; and
sending the encoded data block to the second peer client.

4. The method of claim 1, further comprising:
receiving, by the peer client, a request from a second peer client for content of the streaming media comprising a request for a streaming media segment specifying a sequence number of a segment; and
encoding, by the peer client, an encoded data block dynamically according to the request from the second peer client.

5. The method of claim 1, further comprising:
requesting, by the peer client, a portion of the streaming media content from other peer clients;
receiving encoded data blocks from the other peer clients; and
decoding, by the peer client, received encoded data blocks with a linear network coding method.

6. The method of claim 1, wherein the request comprises providing a set of coefficient vectors.

7. The method of claim 6, wherein encoding comprises selecting a coefficient set independent of coefficient vectors provided to the streaming source from the peer client.

8. The method of claim 1, wherein encoding comprises a linear encoding operation.

9. The method of claim 8, wherein encoding further comprises encoding with linear operations over a finite field.

10. The method of claim 1, further comprising including coefficient information in the encoded data block.

11. A method of encoding and decoding streaming content by streaming content segments, comprising:
requesting, by a peer client, streaming content by providing a sequence number of a data segment to a streaming source;
receiving an encoded data block including the data segment; and
decoding the encoded data block with a linear network decoding routine when sufficient data blocks are received.

12. The method of encoding and decoding of claim 11, further comprising:
receiving, by the streaming source, a request for streaming content with a specified sequence number;
encoding a plurality of data segments of a data segment subset into an encoded data block that includes a segment with the specified sequence number with a linear network coding routine; and
sending the encoded data block to a peer client that issued the request.

13. The method of encoding and decoding of claim 12, wherein encoding further comprises encoding the plurality of data segments with pre-defined coefficient vectors.

14. The method of encoding and decoding of claim 12, wherein encoding further comprises encoding the plurality of data segments with coefficient vectors that are generated randomly.

15. A method of encoding and decoding streaming content, comprising:
submitting a request to a streaming source, by a peer client, for an encoded data block by specifying a sequence number of a video data segment and a number of data segments to be encoded;
receiving an encoded data block; and
decoding the encoded data block with a linear network coding routine.

16. The method of encoding and decoding of claim 15, further comprising:
receiving, by the streaming source, the request;
encoding a data block that includes the segment having the sequence number with a linear network coding routine; and
sending the encoded data block to the peer client.

17. The method of encoding and decoding of claim 16, wherein encoding comprises encoding the data segments with coefficient vectors that are pre-defined.

18. The method of encoding and decoding of claim 16, wherein encoding comprises encoding the data segments with coefficient vectors that are generated randomly.

19. A system for delivering streaming content in a peer-to-peer network, comprising:
a streaming source server that divides the streaming content into data segments of equal length, encodes the data segments in an encoded data block by a linear network coding routine, and sends the encoded data blocks to one or more nodes of the peer-to-peer network; and
a first peer client connected to the peer-to-peer network that requests at least a portion of the data segments, receives the encoded data block from the streaming source server, and decodes the received data block by a linear network coding routine.

20. The system of claim 19, further comprising a second peer client that connects to the first peer client, submits a request for an encoded data block therefrom, wherein the request includes parameters, and receives an encoded data block from the first peer client.

21. The system of claim 19, wherein the first peer client receives a request for streaming content from a second peer client and sends an encoded data block to the second peer client.

22. The system of claim 21, wherein the first peer client dynamically encodes streaming content data segments with a linear network coding routine.

23. The system of claim 19, further comprising a control server that receives a request for a peer list from a peer client, transmits a peer list to the peer client that includes connectivity information of nodes connected in the peer-to-peer network, and stores connectivity information of the peer client.

24. The system of claim 23, wherein the peer list includes connectivity information of the server.

25. A computer-readable medium having computer-executable instructions for execution by a processing system, the computer-executable instructions for delivering streaming content in a peer-to-peer network, comprising:
instructions that divide the streaming content into a plurality of data segments of equal length;
instructions that encode into an encoded data block the plurality of data segments with a linear network coding routine; and
instructions that transmit the encoded data block in the peer-to-peer network.

26. The computer-readable medium of claim 25, further comprising instructions that compute a coefficient vector for the plurality of data segments.

27. The computer-readable medium of claim 25, further comprising instructions that compute a decoding matrix for the encoded data block.

28. The computer-readable medium of claim 25, wherein the instructions that encode compute an independent coefficient vector from an input comprising coefficient vectors for linear network coding.

29. The computer-readable medium of claim 25, further comprising instructions that generate a coefficient vector dynamically for the linear network coding routine, wherein the instructions that encode use pre-defined coefficient vectors for the linear network coding routine.

30. The computer-readable medium of claim 25, further comprising:
instructions that generate a peer list of connectivity information of one or more nodes in the peer to peer network including connectivity information of a streaming source that originated the streaming content; and
instructions that transmit the peer list to one or more nodes in the peer-to-peer network.

31. The computer-readable medium of claim 25, further comprising:
instructions that request streaming content from a streaming source server and peer clients;
instructions that receive encoded data blocks from one or more of the streaming source server and peer clients; and
instructions that decode the encoded data blocks.
